(19) United States
(12) Patent Application Publication
(10) Pub. No.: US 2005/0076160 A1
(43) Pub. Date: Apr. 7, 2005

(54) Using logical names as a string to distinguish logical controls

(76) Inventors: William F. McWalter, Stirling (GB); Vladimir K. Beliaev, Santa Clara, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 10/680,736

(22) Filed: Oct. 6, 2003

(51) Int. Cl. G06F 3/00

(52) U.S. Cl. 710/3; 710/15; 710/8

(57) ABSTRACT

An invention is provided abstracting device names in a system. The invention includes receiving a logical name indicating a device type of physical device present in a system. A physical device in the system then is selected, which has a device type indicated by the logical name. Next, a physical device name is determined for a software component representing the selected physical device. In one aspect, the physical device name can be provided to a requesting application program. In this case, the physical device name can be a character string. Optionally, a handle to the software component can be provided to the requesting application program. The logical name can be a generic character string indicating a device type of a physical device present in a system.

### CROSS REFERENCE TO RELATED APPLICATIONS

This application is related to U.S. patent application Ser. No. ______ (Attorney Docket No. SUNMP152), filed Oct. 6, 2003, and entitled “Logical Devices as a Wrapper for Physical Devices in a System,” which is incorporated herein by reference.

### BACKGROUND OF THE INVENTION

1. Field of the Invention

This invention relates generally to software control of physical devices, and more particularly to methods for using logical names as a string to distinguish logical controls.

2. Description of the Related Art

Telematics, a broad term that refers to vehicle-based wireless communication systems and information services, promises to combine vehicle safety, entertainment, control functions, and convenience features through wireless access to distributed networks, such as the Internet. Telematics offers the promise to move away from the hardware-centric model from audio and vehicle control systems that are built into devices that are custom designed for each vehicle, to systems delivered by plug-and-play hardware whose functionality can be upgraded through software loads or simple module replacement. Furthermore, new revenue streams will be opened up to automobile manufacturers and service providers through the products and services made available through telematics.

However, when generating telematics software it is often necessary to include computer code that interacts with the various physical controls present in the vehicle. Unfortunately, the large number of physical controls, such as sliders, dials, keypads, buttons, etc., which are currently available in today's automobiles, gives rise to difficulties when constructing a user friendly user interface system. Moreover, new physical controls continue to be developed, which further increases the difficulty in constructing user interfaces that account for all the physical controls.

As is well known to those skilled in the art, physical objects, such as the physical controls, are often logically represented in a computer program using some form of variable. These variables have variable names that are descriptive of the control and its environment. For example, a radio control dial in a Honda automobile could be represented by the variable HondaRadioControlDial. Unfortunately, this descriptiveness in the variable naming conventions creates difficulties when attempting to develop platform-independent telematic applications.

As a result, conventional application programs generally must decide ahead of time which physical controls their application program will be capable of interacting with. For example, a prior art temperature control telematics program might, for example, be developed to work with an air conditioning unit that uses a dial to increase and decrease the temperature. In this case, the application program would generally be developed with the dial interaction code, which actually interacts with the dial, hard coded into the application program. As a result, the application program cannot be utilized in an automobile using a slider control to increase and decrease the temperature.

In view of the foregoing, there is a need for techniques that account for different object and variable naming conventions to promote platform-independent program creation. The techniques should allow application developers to access a plurality of different physical devices in the same or similar manner. Thus allowing the application programs to be ported to different systems having different physical controls.

### SUMMARY OF THE INVENTION

Broadly speaking, the present invention fills these needs by abstracting physical devices in a system. Embodiments of the present invention provides a mechanism that allows software applications to obtain physical device names for software components, which represent the physical devices in a system.

In one embodiment, a method is disclosed for abstracting device names in a system. The method includes receiving a logical name indicating a device type of physical device present in a system. A physical device in the system then is selected, which has a device type indicated by the logical name. Next, a physical device name is determined for a software component representing the selected physical device. In one aspect, the physical device name can be provided to a requesting application program. In this case, the physical device name can be a character string. Optionally, a handle to the software component can be provided to the requesting application program. The logical name can be a generic character string indicating a device type of physical device present in a system.

A computer program embodied on a computer readable medium for abstracting device names in a system is disclosed in an additional embodiment. The computer program includes computer program instructions that receive a logical name indicating a device type of physical device present in a system. Computer program instructions are also included that select a physical device in the system, the physical device having a device type indicated by the logical name. In addition, computer program instructions are included that determine a physical device name for a software component representing the selected physical device. Similar to above, in one aspect, computer program instructions can be included that provide the physical device name to a requesting application program, wherein the physical device name is a character string.

Optionally, computer program instructions can be included that provide a handle to the software component to a requesting application program. Also as above, the logical name can be a generic character string indicating a device type of physical device present in a system. In one aspect, the software component can be a logical device object. The logical device object can include a physical device implementation code segment capable receiving device data from a physical device, and an application programming interface (API) that is in communication with a physical device implementation code segment. The API is capable of receiving the device data from the physical device code segment. In this manner, an application program can communicate with the API to access the device data.

A system for abstracting device names in a system is disclosed in a further embodiment of the present invention. The system includes an application program and a logical device manager capable of providing access to a particular software component in response to receiving a software component type request from the application program. In addition, the system includes one or more software components. Each software component is capable of performing a particular function, and has a software component type and a software component name. In operation, the application program provides a logical name indicating a software component type present in the system. The logical device manager then determines the software component name based on the software component type. Similar to above, the logical device manager can provide the software component name to the application program.

Optionally, the logical device manager can provide a handle to the software component to the application program. For example, in one aspect, the software component type request can be a generic character string indicating a type of software component present in a system. Also as above, the software component can be a logical device object that includes a physical device implementation code segment capable receiving device data from a physical device and an API interface in communication with a physical device implementation code segment. The API interface, for example, can be capable of receiving the device data from the physical device code segment. In this manner, the application program can communicate with the API interface to access the device data.

### BRIEF DESCRIPTION OF THE DRAWINGS

The invention, together with further advantages thereof, may best be understood by reference to the following description taken in conjunction with the accompanying drawings in which:

FIG. 1 is an illustration showing a plurality of exemplary one-dimensional physical controls that can be present in an automobile or other system;

FIG. 2 is a block diagram illustrating an exemplary one-dimensional logical device object in accordance with an embodiment of the present invention;

FIG. 3 is a high level block diagram illustrating logical device usage in a telematics based system, in accordance with an embodiment of the present invention;

FIG. 4 is a flowchart showing a method for using generic logical device names as strings to distinguish logical controls, in accordance with an embodiment of the present invention;

FIG. 5 is a block diagram illustrating a logical device manager, in accordance with an embodiment of the present invention.

### DETAILED DESCRIPTION

An invention is disclosed for a method for abstracting software component device names in a system. Embodiments of the present invention provide a mechanism that allows software applications to obtain physical device names for software components, which represent the physical devices in a system. Broadly speaking, using the embodiments of the present invention, application programs are designed utilizing generic logical names for the physical devices in a system. When the application program is executed in a particular system, the actual physical device names for the software components representing the physical devices are mapped to the generic logical names. In this manner, application programs can be designed and compiled without prior knowledge of the actual physical devices in a system.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

As mentioned above, embodiments of the present invention provide a mechanism that allows software applications to obtain the physical device names for software components that represent the physical devices in a system. In one embodiment, the software components can be logical devices as described in U.S. patent application Ser. No. ______ (Attorney Docket No. SUNMP152), filed Oct. 6, 2003, and entitled “Logical Devices as a Wrapper for Physical Devices in a System,” which is incorporated herein by reference.

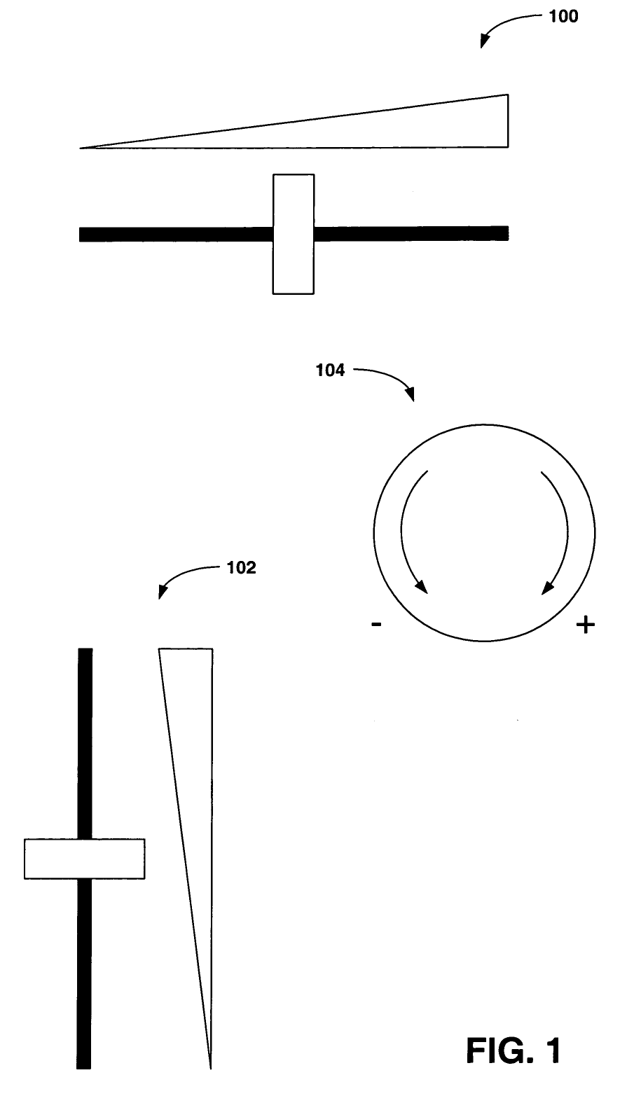

To assist in understanding the embodiments of the present invention, a discussion of logical devices and control dimensionality follows. FIG. 1 is an illustration showing a plurality of exemplary one-dimensional physical controls that can be present in an automobile or other system. As will be described in greater detail subsequently, one-dimensional physical controls are physical controls that provide data for a single variable. As shown in FIG. 1, one-dimensional physical controls can include, for example, a horizontal slider 100, a vertical slider 102, a dial 104, or any other physical control that provides data for essentially a single variable. Although only sliders and dials are illustrated in FIG. 1, it should be noted that a one-dimensional control can include any type of device capable of providing data for a single variable.

As mentioned above, a one-dimensional physical control is a physical control that provides data for a single variable. For example, the horizontal slider 100 of FIG. 1 allows a user to increase the value of a variable by sliding the horizontal slider 100 to the right, and decrease the value by sliding the horizontal slider 100 to the left. In a similar manner, the vertical slider 102 allows a user to increase the value of a variable by sliding the vertical slider 102 up, and decrease the value by sliding the vertical slider 102 down. Although the motion of the dial 104 is different than that of the horizontal and vertical sliders 100 and 102, the affect on a variable is the same. That is, by rotating the dial 104 clockwise, the user can increase the value of a variable. Similarly, by rotating the dial 104 counterclockwise, the user can decrease the value of the variable. As can be appreciated, the controls illustrated in FIG. 1 allow the user to control data for a single variable.

Based on the similarities of physical controls of the same dimension, one embodiment of the present invention utilizes logical devices as wrappers for physical controls of the same dimension. For example, a one-dimensional logical device functions as a wrapper for one-dimensional physical controls, such as sliders and dials, and a two-dimensional logical device functions as a wrapper for two-dimensional physical controls, such as trackballs and touch screens. Hence, as described in greater detail subsequently, logical devices allow application developers to create application programs that interact with the logical devices, which interact with a plurality of similar physical devices, instead of particular physical devices. In this manner, the application program can be executed in any environment having physical controls that can interact with the logical device. For example, an application program can be created to interact with one-dimensional logical devices. Once developed, the application program can be executed with any of the physical controls illustrated in FIG. 1, and also with any other one-dimensional control that is later developed.

In one embodiment, the logical devices can form an application programming interface (API) for use in the Java programming language. Unlike most programming languages, in which a program is compiled into machine-dependent, executable program code, Java classes are compiled into machine independent bytecode class files which are executed by a machine-dependent virtual machine. The virtual machine provides a level of abstraction between the machine independence of the bytecode classes and the machine-dependent instruction set of the underlying computer hardware. A class loader is responsible for loading the bytecode class files as needed, and an interpreter or just-in-time compiler provides for the transformation of bytecodes into machine code.

More specifically, Java is a programming language designed to generate applications that can run on all hardware platforms, small, medium and large, without modification. Developed by Sun, Java has been promoted and geared heavily for the Web, both for public Web sites and intranets. Java is an interpreted language. As mentioned above, the source code of a Java program is compiled into an intermediate language called bytecode. The bytecode is then converted (interpreted) into machine code at runtime. Java platforms execute Java applications by invoking a Java interpreter (Java Virtual Machine), which translates the bytecode into machine code and runs it. Thus, Java application programs are not dependent on any specific hardware and will run in any computer with the Java Virtual Machine software.

When embodied as an API, the logical device API forms a language and message format that can be used by the application program to communicate with the physical devices of the system. The logical device API can be implemented by writing physical device specific methods for each method provided in the logical device API, which provide the linkage to the required subroutine for execution. These method calls form the physical device code for the system. Thus, a logical device API indicates which method calls are available to the application program. Thereafter, each logical device can be instantiated as a separate object for each physical control.

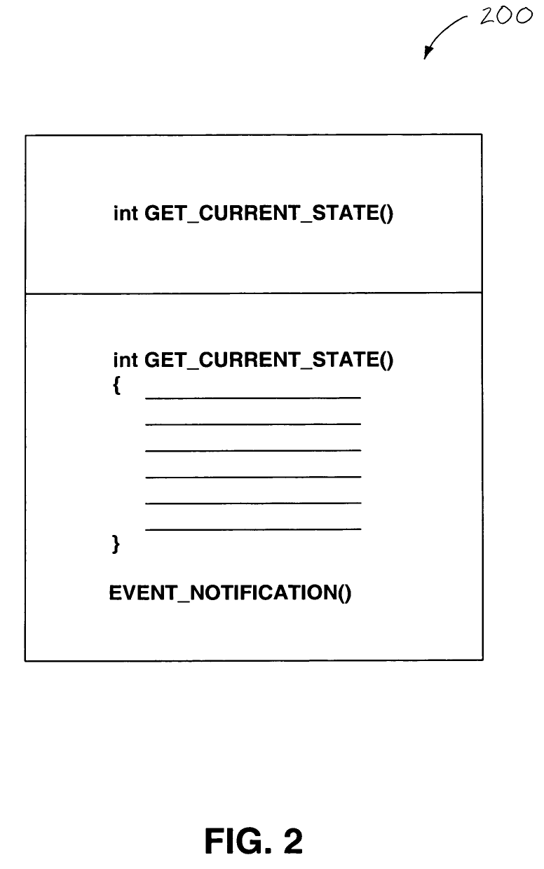

FIG. 2 is a block diagram illustrating an exemplary one-dimensional logical device object 200 in accordance with an embodiment of the present invention. As illustrated in FIG. 2, the exemplary one-dimensional logical device object 200 comprises a method GET_CURRENT_STATE ( ), which provides the current state of the particular physical control represented by the one-dimensional logical device object 200.

For example, the application program can call the method GET_CURRENT_STATE ( ) to obtain the device data for the physical control. For example, in a temperature control application, the application can call the method GET_CURRENT_STATE ( ) to obtain device data indicating whether the temperature should be increased or decreased, and by how many degrees the change should be. In the example of FIG. 2, the interface to the method GET_CURRENT_STATE ( ) corresponds to a logical device.

The actual code for the method GET_CURRENT_STATE ( ) forms physical device code. That is, a developer who is aware of the physical properties and specific interfaces of the particular physical device writes the actual computer instructions that comprise the method GET_CURRENT_STATE ( ). However, the developer should ensure that the method is called and returns the data listed in the logical device. For example, in FIG. 2 the developer of the physical device code should ensure that the method is called as GET_CURRENT_STATE ( ) and returns an integer value indicating the current setting of the physical device. In this manner, the application program does not need to know the specifics of the physical device queried. That is, the application program can call GET_CURRENT_STATE ( ) and can expect to receive an integer value indicating the current setting of the physical device, regardless of whether the device is a slider, dial, or any other one-dimensional physical device.

Another exemplary method that can be present in the one-dimensional object 200 is the method EVENT_NOTIFICATION( ). This method can, for example, be utilized to notify the application program that the current state of the physical device has changed. In this case, the application program can take appropriate action, such as calling the GET_CURRENT_STATE( ) method to obtain the current setting of the physical device. Although the forgoing has been described in terms of the methods GET_CURRENT_STATE ( ) and EVENT_NOTIFICATION( ) it should be noted that any methods and data can be utilized to define a logical device class. Additional logical device information can be found in U.S. patent application incorporated by reference above.

As mentioned above, embodiments of the present invention allow application programs to utilize generic logical names for the physical devices in a system. Then, when the application program is executed in a particular system, the actual physical device names for the software components representing physical devices are mapped to the generic logical names. In this manner, application programs can be designed and compiled without prior knowledge of the actual physical devices in a system.

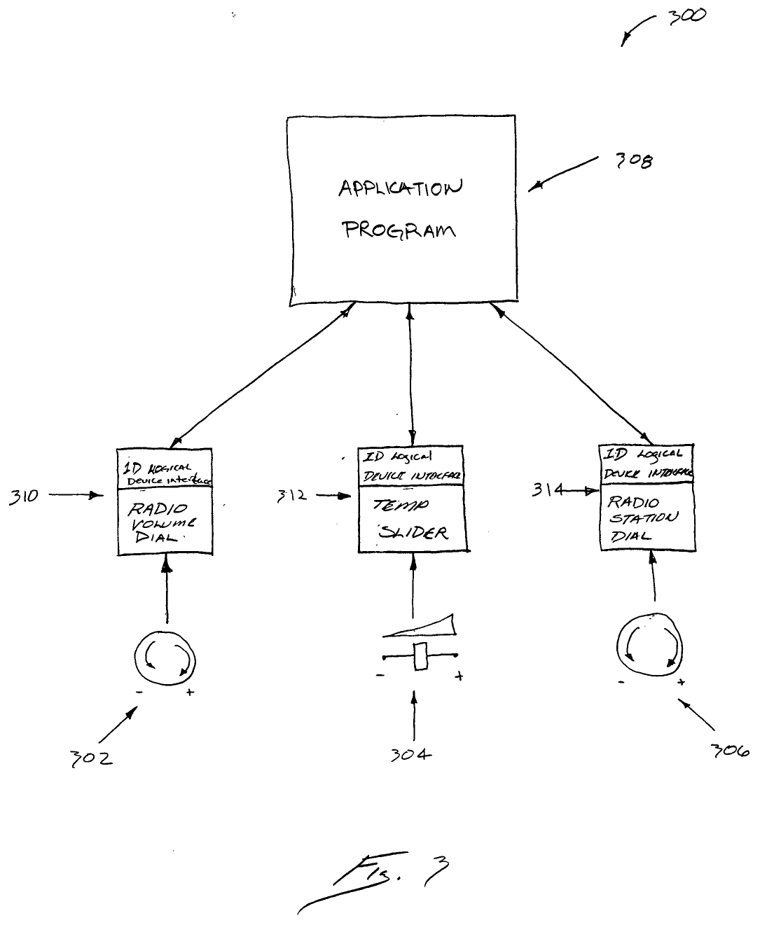

FIG. 3 is a high level block diagram illustrating logical device usage in a telematics based system 300, in accordance with an embodiment of the present invention. Although FIG. 3 will be described in terms of telematics, it should be noted that embodiments of the present invention can be utilized in any system requiring specific object names. The telematics based system 300 includes a plurality of physical devices. For example, in FIG. 3, the exemplary telematics based system 300 includes a radio volume control dial 302, a temperature control slider 304, and a radio station control dial 306.

Each physical device 302-306 has a corresponding one-dimensional logical device object 310-314 that represents the physical device 302-306 in application programs. As mentioned above, the one-dimensional logical device objects provide an interface between the application program 308 and the actual physical device 302-306. For example, in FIG. 3, a RadioVolumeDial logical device object 310 represents the radio volume control dial 302 physical device, a TempSlider logical device object 312 represents the temperature control slider 304 physical device, and a RadioStationDial logical device object 314 represents the radio station control dial 306 physical device. In operation, the application program 308 can obtain device data from the physical devices 302-306 utilizing the corresponding one-dimensional logical device object 310-312.

As can be appreciated, different systems can have different controls and physical device code for the devices that perform essentially the same purpose. For example, a Cadillac automobile telematics system may utilize a dial based physical device for a temperature control 304, while a Nissan automobile telematics system may utilize a slider based physical device for a temperature control 304. However, since both physical controls are represented using the one-dimensional control API, the application program 308 can be utilized in both systems.

Generally, descriptive names are utilized for the program objects in a system, such as the logical device objects. For example, a Cadillac temperature control logical device object may be named ‘CadillacTempDial,’ while a Nissan temperature control logical device object may be named ‘NissanTempSlider.’ Embodiments of the present invention allow the application program 308 to be utilized in both systems through the use of generic logical names for the physical devices in a system. Then, when the application program is executed in a particular system, the actual physical device names for the software components representing physical devices are mapped to the generic logical names.

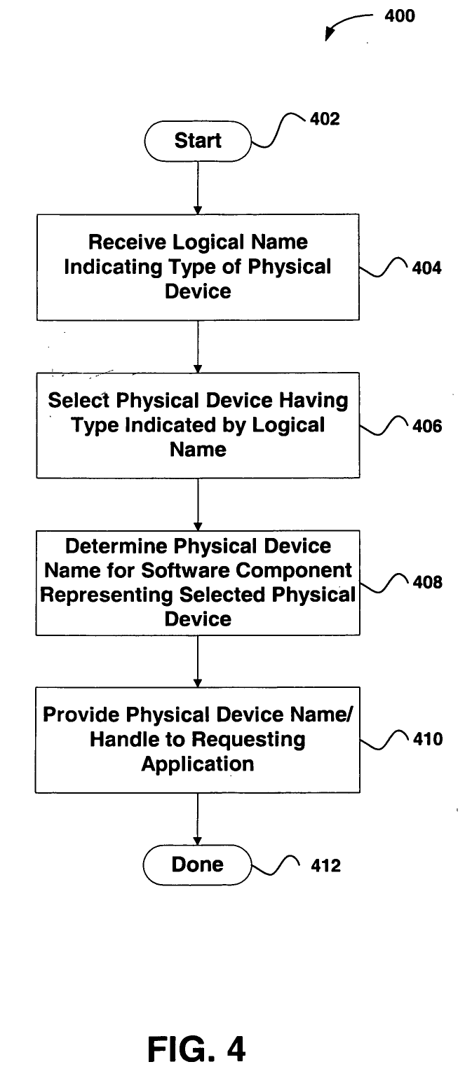

For example, the application program 308 can represent a temperature slider using a generic logical device name, such as ‘TempControl.’ Since the application program 308 generally only requires device data, such as the state of the temperature control device, the application program 308 can interact with a generic TempControl object that represents a one-dimensional logical device object for a temperature control. That is, the application program is generally not concerned with the specifics of how a particular control operates, the application program generally only wants the data the control provides. Using the embodiments of the present invention, the actual logical device for the temperature control is mapped to the generic logical device name ‘TempControl’ when the application program is later executed in a particular system. For example, when the application program 308 is executed in the above Cadillac system, the generic logical device name ‘TempControl’ is mapped to the logical device object ‘CadillacTempDial.’ Similarly, when the application program 308 is executed in the above Nissan system, the generic logical device name ‘TempControl’ is mapped to the logical device object ‘NissanTempSlider.’ To provide the logical device name mapping, embodiments of the present invention utilize a logical device manager, as described next with reference to FIG. 4.

FIG. 4 is a flowchart showing a method 400 for using generic logical device names as strings to distinguish logical controls, in accordance with an embodiment of the present invention. Embodiments of the present invention utilize a logical device manager to map the logical names utilized in application programs to the actual one-dimensional logical device object names utilized in the particular system. In an initial operation 402, preprocess operations are performed. Preprocess operations can include, for example, designing the application program, registering logical devices with a logical device manager, and other preprocess operations that will be apparent to those skilled in the art after a careful reading of the present disclosure.

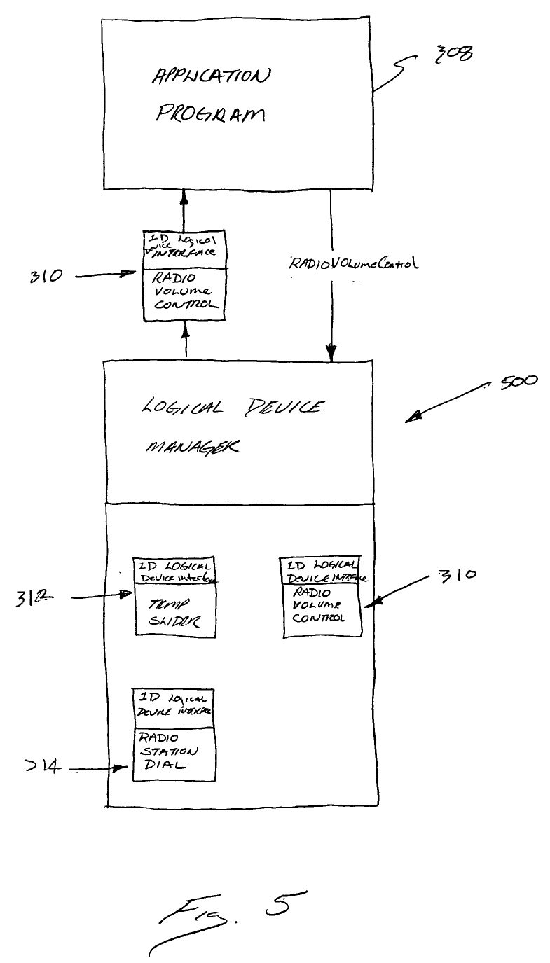

In operation 404, a logical name is received that indicates a type of physical device. Generally speaking, the application program indicates to the logical device manager the type of control it wants, as illustrated in FIG. 5. FIG. 5 is a block diagram illustrating a logical device manager 500, in accordance with an embodiment of the present invention. The logical device manager 500 is responsible for determining which logical device is being requested based on the type of physical device requested. For example, in operation 404, the application program 308 may request the radio volume control for the system by passing the string “RadioVolumeControl” to the logical device manager 500. In this example, the string “RadioVolumeControl” indicates that the application program 308 is requesting the logical device that represents the physical device that controls the radio volume in the system.

Referring back to FIG. 4, the physical device having the type indicated by the logical name is selected, in operation 406. Turning to FIG. 5, the logical name “RadioVolumeControl,” for example, indicates to the logical device manager 500 that the 20 application program 308 is requesting the actual physical device name for the radio volume control of the system. Thus, upon receiving the logical name “RadioVolumeControl,” the logical device manager 500 selects the physical device in the system corresponding to the radio volume control.

Retuning to FIG. 4, in operation 408, the actual physical device name for the software component representing the selected physical device is determined. Referring to FIG. 5, the logical device manager 500 determines which software component 310-314 represents the radio volume control for the system. For example, in FIG. 5, the logical device manager will determine that software component 310 represents a radio volume control for the system. At this point, the logical device manager 500 determines the actual physical device name for the software component 310. For example, in a Cadillac system the radio volume control software component 310 may have the physical device name “CadillacRadioVolumeControl.”

In one embodiment, software components 310-314 representing the physical devices in the system are registered with the logical device manager prior to program execution. In this manner, the logical device manager 500 will be made aware of which physical devices are present in the system prior to program execution. In addition, the logical device manager 500 will be aware of the type of physical devices available and the actual physical device names of the software components representing the physical devices in the system.

Then, in operation 410, the physical device name and/or handle is provided to the requesting application. Returning to FIG. 5, once the logical device manager 500 has determined the actual physical device name for software component 310, the logical device manager 500 provides the physical device name to the requesting application 308. For example, the logical device manager 500, in the example of FIG. 5, can provide the physical device name “CadillacRadioVolumeControl” to the application program 308. Optionally, the logical device manager 500 can return the handle, or other software pointer, to the software component 310 that represents the radio volume control for the system. In this manner, the application program 308 can obtain the physical device name or handle to the software component representing the radio volume control physical device without prior knowledge of the specific telematics operating environment in which the application program 308 will be executed.

Referring back to FIG. 4, post process operations are performed in operation 412. Post process operations can include, for example, receiving further logical names from the application program, registering additional physical devices with the logical device manager, and other post process operations that will be apparent to those skilled in the art after a careful reading of the present disclosure.

Although the present invention is described based on the Java programming language, other programming languages may be used to implement the embodiments of the present invention, such as other object oriented programming languages. Object-oriented programming is a method of creating computer programs by combining certain fundamental building blocks, and creating relationships among and between the building blocks. The building blocks in object-oriented programming systems are called “objects.” An object is a programming unit that groups together a data structure ( variables or fields) and the operations (methods) that can use or affect that data. Thus, an object consists of data and one or more operations or procedures that can be performed on that data. The joining of data and operations into a unitary building block is called “encapsulation.”

An object can be instructed to perform one of its methods when it receives a “message.” A message is a command or instruction to the object to execute a certain method. It consists of a method selection (name) and a plurality of arguments that are sent to an object. A message tells the receiving object what operations to perform.

One advantage of object-oriented programming is the way in which methods are invoked. When a message is sent to an object, it is not necessary for the message to instruct the object how to perform a certain method. It is only necessary to request that the object execute the method. This greatly simplifies program development.

Object-oriented programming languages are predominantly based on a “class” scheme. A class defines a type of object that typically includes both variables and methods for the class. An object class is used to create a particular instance of an object. An instance of an object class includes the variables and methods defined for the class. Multiple instances of the same class can be created from an object class. Each instance that is created from the object class is said to be of the same type or class.

A hierarchy of classes can be defined such that an object class definition has one or more subclasses. A subclass inherits its parent's (and grandparent's etc.) definition. Each subclass in the hierarchy may add to or modify the behavior specified by its parent class.

To illustrate, an employee object class can include “name” and “salary” variables and a “set_salary” method. Instances of the employee object class can be created, or instantiated for each employee in an organization. Each object instance is said to be of type “employee.” Each employee object instance includes the “name” and “salary” variables and the “set_salary” method. The values associated with the “name” and “salary” variables in each employee object instance contain the name and salary of an employee in the organization. A message can be sent to an employee's employee object instance to invoke the “set_salary” method to modify the employee's salary (i.e., the value associated with the “salary” variable in the employee's employee object).

An object is a generic term that is used in the object-oriented programming environment to refer to a module that contains related code and variables. A software application can be written using an object-oriented programming language whereby the program's functionality is implemented using objects. Examples of object-oriented programming languages include C++ as well as Java.

Furthermore the invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the invention are useful machine operations. The invention also relates to a device or an apparatus for performing these operations. The apparatus may be specially constructed for the required purposes, such as the TCU discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which can be thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A method for abstracting device names in a system, comprising the operations of:
receiving a logical name indicating a device type of physical device present in a system;
selecting a physical device in the system, the physical device having a device type indicated by the logical name; and
determining a physical device name for a software component representing the selected physical device.

2. A method as recited in claim 1, further comprising the operation of providing the physical device name to a requesting application program, wherein the physical device name is a character string.

3. A method as recited in claim 1, further comprising the operation of providing a handle to the software component to a requesting application program.

4. A method as recited in claim 1, wherein the logical name is a generic character string indicating a device type of physical device present in a system.

5. A method as recited in claim 1, wherein the software component is a logical device object, the logical device object including a physical device implementation code segment capable receiving device data from a physical device, the logical device object further including an application programming interface (API) in communication with a physical device implementation code segment, wherein the API is capable of receiving the device data from the physical device code segment.

6. A method as recited in claim 5, wherein an application program can communicate with the API to access the device data.

7. A method as recited in claim 1, further comprising the operation of registering software components representing physical devices in the system with a logical device manager, the logical device manager capable of receiving the logical name from an application program.

8. A computer program embodied on a computer readable medium, the computer program capable of abstracting device names in a system:
computer program instructions that receive a logical name indicating a device type of physical device present in a system;
computer program instructions that select a physical device in the system, the physical device having a device type indicated by the logical name; and
computer program instructions that determine a physical device name for a software component representing the selected physical device.

9. A computer program as recited in claim 8, further comprising computer program instructions that provide the physical device name to a requesting application program, wherein the physical device name is a character string.

10. A computer program as recited in claim 8, further comprising computer program instructions that provide a handle to the software component to a requesting application program.

11. A computer program as recited in claim 8, wherein the logical name is a generic character string indicating a device type of physical device present in a system.

12. A computer program as recited in claim 8, wherein the software component is a logical device object, the logical device object including a physical device implementation code segment capable receiving device data from a physical device, the logical device object further including an application programming interface (API) in communication with a physical device implementation code segment, wherein the API is capable of receiving the device data from the physical device code segment.

13. A computer program as recited in claim 12, wherein an application program can communicate with the API to access the device data.

14. A computer program as recited in claim 8, further comprising computer program instructions that register software components representing physical devices in the system with a logical device manager, the logical device manager capable of receiving the logical name from an application program.

15. A system for abstracting device names in a system, comprising:
an application program;
a logical device manager capable of providing access to a particular software component in response to receiving a software component type request from the application program; and
a software component capable of performing a particular function, the software component having a software component type, the software component further having a software component name,
wherein the application program provides a logical name indicating a software component type present in the system, and wherein the logical device manager determines the software component name based on the software component type.

16. A system as recited in claim 15, wherein the logical device manager provides the software component name to the application program, wherein the physical device name is a character string.

17. A system as recited in claim 15, wherein the logical device manager provides a handle to the software component to the application program.

18. A system as recited in claim 15, wherein the software component type request is a generic character string indicating a type of software component present in a system.

19. A system as recited in claim 15, wherein the software component is a logical device object, the logical device object including a physical device implementation code segment capable receiving device data from a physical device, the logical device object further including an API in communication with a physical device implementation code segment, wherein the API is capable of receiving the device data from the physical device code segment.

20. A system as recited in claim 19, wherein the application program can communicate with one of the API and logical device to access the device data.
